(19) United States
(12) Patent Application Publication
(10) Pub. No.: US 2022/0187846 A1
(43) Pub. Date: Jun. 16, 2022

(54) TRANSPORT SYSTEM AND TRANSPORT VEHICLE

(71) Applicant: NIDEC CORPORATION, Kyoto (JP)

(72) Inventors: Shohei IMADA, Kyoto (JP); Tomoki YOSHIKAWA, Kyoto (JP); Shuhei OGAWA, Kyoto (JP)

(21) Appl. No.: 17/429,934

(22) PCT Filed: Jan. 8, 2020
(86) PCT No.: PCT/JP2020/000253

§ 371 Date: Aug. 10, 2021

(30) Foreign Application Priority Data
Feb. 20, 2019 (JP) 2019-028804

(51) Int. Cl. G05D 1/02; G01G 19/08; B60L 50/60

(52) U.S. Cl. CPC G05D 1/0291; B60L 50/60; G01G 19/08

(57) ABSTRACT

One aspect of a transport system of the present invention includes a plurality of transport vehicles that cooperatively transport an object; and a transport control unit that controls the plurality of transport vehicles to transport the object. Each of the plurality of transport vehicles includes a load measuring unit that measures a load applied from the object. In a case where there is a plurality of moving routes of the plurality of transport vehicles when transporting the object from a current location to a predetermined destination, the transport control unit selects each of the moving routes of the plurality of transport vehicles based on a measurement result of the load measuring unit.

### CROSS-REFERENCE TO RELATED APPLICATIONS

This is the U.S. national stage of application No. PCT/JP2020/000253, filed on Jan. 8, 2020, and priority under 35 U.S.C. § 119(a) and 35 U.S.C. § 365(b) is claimed from Japanese Patent Application No. 2019-028804, filed on Feb. 20, 2019; the disclosures of which are incorporated herein by reference.

### FIELD OF THE INVENTION

The present invention relates to a transport system and a transport vehicle.

### BACKGROUND

A transport system by a transport vehicle is known. For example, there is known a traveling system of an unmanned vehicle that selects a via-point on a traveling route for the purpose of improving workability of loading work.

As a transport system, a transport system that transports an object by coordinating a plurality of transport vehicles can be considered. In this case, when the route selection of the plurality of transport vehicles is performed in the same manner as in the case of performing the route selection in one transport vehicle, there is a case where the transport efficiency of the entire transport system cannot be sufficiently improved.

### SUMMARY

One aspect of an exemplary transport system of the present invention includes a plurality of transport vehicles that cooperatively transport an object; and a transport control unit that controls the plurality of transport vehicles to transport the object. Each of the plurality of transport vehicles includes a load measuring unit that measures a load applied from the object. In a case where there is a plurality of moving routes of the plurality of transport vehicles when transporting the object from a current location to a predetermined destination, the transport control unit selects each of the moving routes of the plurality of transport vehicles based on a measurement result of the load measuring unit.

One aspect of an exemplary transport vehicle of the present invention includes: a transport control unit that transports an object in cooperation with another transport vehicle; and a load measuring unit that measures a load applied from the object. According to one aspect of the transport vehicle of the present invention, in a case where there is a plurality of moving routes of the other transport vehicle when transporting the object from the current location to a predetermined destination, the transport control unit selects the moving route of the other transport vehicle based on a measurement result of the load measuring unit included in the transport vehicle and a measurement result of the load measuring unit included in the other transport vehicle.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram of a transport system of this embodiment as viewed from above;

FIG. 2 is a diagram illustrating a part of a procedure of transporting an object in the transport system of this embodiment;

FIG. 3 is a diagram illustrating another part of the procedure of transporting an object in the transport system of this embodiment;

FIG. 4 is a flowchart illustrating a procedure of transporting an object in the transport system of this embodiment;

FIG. 5 is a diagram illustrating an example of a moving method of a plurality of transport vehicles when a direction of an object is changed in the transport system of this embodiment;

FIG. 6 is a diagram illustrating another example of the moving method of the plurality of transport vehicles when the direction of the object is changed in the transport system of this embodiment;

FIG. 7 is a diagram illustrating a part of a procedure of transporting an object in another example of the transport system of this embodiment; and

FIG. 8 is a diagram illustrating another part of a procedure of transporting an object in another example of the transport system of this embodiment.

### DETAILED DESCRIPTION

A Z-axis direction appropriately illustrated in each drawing is a vertical direction. The positive side in the Z-axis direction is a vertically upper side. A negative side in the Z-axis direction is a vertically lower side. The X-axis direction and the Y-axis direction appropriately illustrated in each drawing are horizontal directions orthogonal to the vertical direction, and are directions orthogonal to each other. In the following description, the Z-axis direction that is the vertical direction is referred to as a “vertical direction Z”. In the following description, the vertically upper side and the vertically lower side will be referred to simply as the “upper side” and the “lower side”, respectively. The X-axis direction in the horizontal direction is referred to as a “first horizontal direction X”, and the Y-axis direction in the horizontal direction is referred to as a “second horizontal direction Y”.

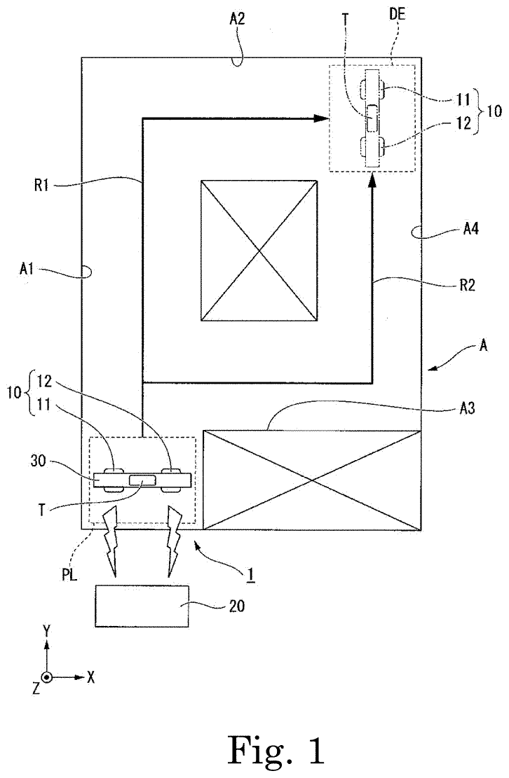

In the following embodiment, an example will be described in which a transport system 1 transports an object T from a current location PL to a predetermined destination DE in a workplace A illustrated in FIG. 1. As illustrated in FIG. 1, the workplace A has passages A1, A2, A3, and A4. The passage A1 extends from the current location PL to one side (+Y side) in the second horizontal direction Y. The passage A2 extends from an end of the passage A1 on one side in the second horizontal direction Y to one side (+X side) in the first horizontal direction X. The passage A3 extends from the middle of the passage A1 to one side in the first horizontal direction X. The passage A4 extends from an end of the passage A3 on one side in the first horizontal direction X to one side in the second horizontal direction Y. An end of the passage A4 on one side in the second horizontal direction Y is connected to an end of the passage A2 on one side in the first horizontal direction X. A place where the passage A2 and the passage A4 are connected is the destination DE.

The transport system 1 of this embodiment includes a plurality of transport vehicles 10, a plate member 30, and a transport control unit 20. The transport control unit 20 controls the plurality of transport vehicles 10 to transport the object T. In this embodiment, the transport control unit 20 is provided separately from the plurality of transport vehicles 10. The plurality of transport vehicles 10 are unmanned transport vehicles that cooperatively transport the object T. In this embodiment, the plurality of transport vehicles 10 cooperatively hold and transport the object T. In this embodiment, two transport vehicles 10, i.e., a transport vehicle 11 and a transport vehicle 12, are provided. In this embodiment, the transport vehicle 11 and the transport vehicle 12 have the same structure.

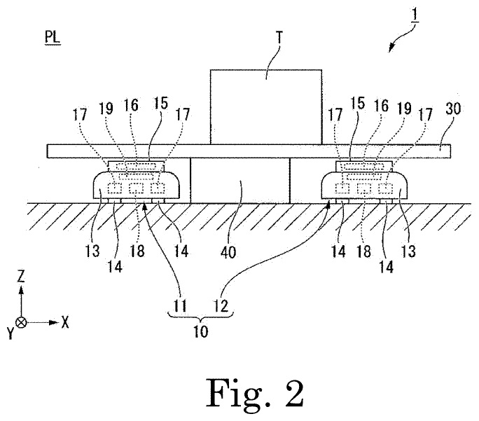

As illustrated in FIG. 2, each of the plurality of transport vehicles 10 includes a vehicle body 13, a plurality of wheels 14, a motor 17, a battery 18, a cargo bed 15, a lifting device 19, and a load measuring unit 16. The plurality of wheels 14 are attached to the vehicle body 13. The plurality of wheels 14 are, for example, wheels rotatable in a plurality of directions of the horizontal direction. Therefore, the transport vehicle 10 of this embodiment can move in a plurality of horizontal directions without changing the direction. For example, the transport vehicle 10 can move in each of the first horizontal direction X and the second horizontal direction Y without changing the direction.

The motor 17 is disposed inside the vehicle body 13. The motor 17 drives the wheels 14. In this embodiment, the motor 17 is provided for each wheel 14. The battery 18 is disposed inside the vehicle body 13. The battery 18 supplies power to the motor 17. In this embodiment, the battery 18 supplies power to the plurality of motors 17. The battery 18 may be provided for each motor 17.

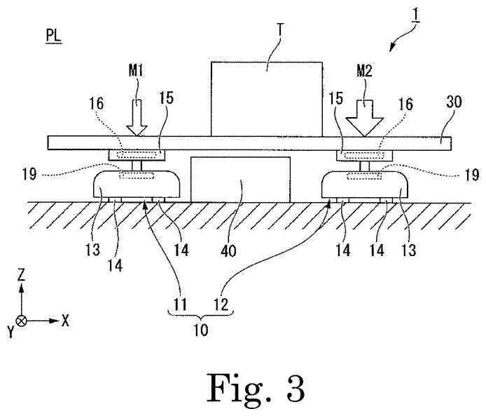

The cargo bed 15 is located on the upper side of the vehicle body 13. The object T is loaded on the cargo bed 15. The object T is loaded on the cargo bed 15 of this embodiment via the plate member 30. That is, in this embodiment, the plurality of transport vehicles 10 transport the object T loaded on the plate member 30. The lifting device 19 is disposed inside the vehicle body 13. As illustrated in FIGS. 2 and 3, the lifting device 19 moves the cargo bed 15 in the vertical direction Z.

In this embodiment, the load measuring unit 16 is disposed inside the cargo bed 15. The load measuring unit 16 measures a load applied from the object T to the transport vehicle 10. In the present specification, the “load applied from the object to the transport vehicle” includes a load applied from the object and another member to the transport vehicle when the object is transported via another member. In this embodiment, the load measuring unit 16 measures the load applied from the object T loaded on the cargo bed 15 and the plate member 30 as another member.

The load measuring unit 16 is not particularly limited as long as it can measure the load applied to the transport vehicle 10. The load measuring unit 16 may be, for example, a one-axis force sensor or a six-axis force sensor. In a case where the load measuring unit 16 is a six-axis force sensor, the load measuring unit 16 may detect a force, a moment, and the like applied to the transport vehicle 10 in addition to the load applied from the object T to the transport vehicle 10.

The plate member 30 is a plate-like member whose plate surface faces the vertical direction Z. The material of the plate member 30 is not particularly limited. The plate member 30 extends in one direction of the horizontal direction. In FIGS. 1 to 3, the plate member 30 extends, for example, in the first horizontal direction X. As illustrated in FIG. 1, the plate member 30 has a rectangular shape when viewed along the vertical direction Z. In the following description, a direction in which the plate member 30 extends is referred to as a “longitudinal direction”.

As illustrated in FIG. 3, the plate member 30 is supported from the lower side by the plurality of transport vehicles 10. In this embodiment, the plate member 30 is supported from the lower side by the cargo bed 15 of the transport vehicle 11 and the cargo bed 15 of the transport vehicle 12. Through the plate member 30, it is easy to hold the object T in cooperation by the plurality of transport vehicles 10, and it is easy to transport the object T. In this embodiment, the plate member 30 is not fixed to the transport vehicle 10 in a state of being supported by the plurality of transport vehicles 10 from the lower side. In this embodiment, when moving each transport vehicle 10, the transport control unit 20 controls the speed and the like of each transport vehicle 10 to maintain the relative position and the relative posture between each transport vehicle 10 and the plate member 30.

As illustrated in FIG. 2, the plate member 30 is arranged on the placing table 40 in a state of not being supported by the transport vehicle 10, and is supported from the lower side by the placing table 40. Although not illustrated, the placing table 40 is disposed at the current location PL and the destination DE, for example. The horizontal dimension of the placing table 40 is smaller than the longitudinal dimension of the plate member 30. The dimension of the placing table 40 in the vertical direction Z is larger than the dimension of the transport vehicle 10 in the vertical direction Z in a state where the cargo bed 15 is located on the lowermost side, and is smaller than the dimension of the transport vehicle 10 in the vertical direction Z in a state where the cargo bed 15 is located on the uppermost side. The plate member 30 protrudes from the placing table 40 to both sides in the longitudinal direction in a state of being arranged on the placing table 40.

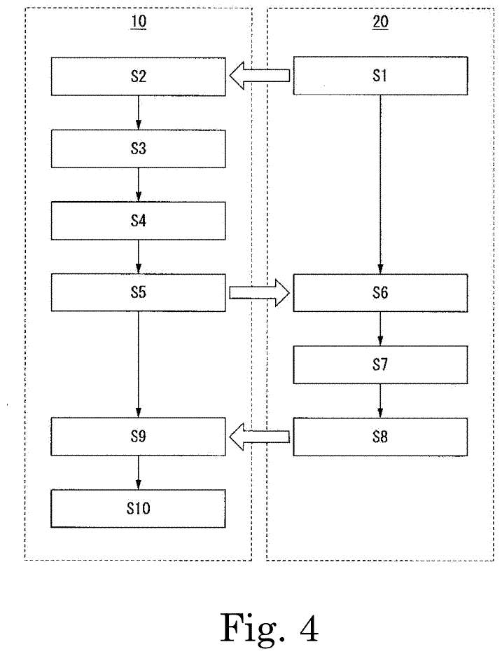

The transport system 1 of this embodiment transports the object T from the current location PL to the destination DE along Steps S1 to S10 illustrated in FIG. 4. Step S1 is a step in which the transport control unit 20 transmits a loading instruction to each transport vehicle 10. Specifically, in Step S1, the transport control unit 20 transmits an instruction to load the object T on the cargo bed 15 to each transport vehicle 10. Step S2 is a step in which each transport vehicle 10 receives a loading instruction from the transport control unit 20.

Step S3 is a step in which each transport vehicle 10 that has received the loading instruction loads the object T in cooperation with the other transport vehicles 10. In Step S3, as illustrated in FIG. 2, the transport vehicle 10 moves to the lower side of the plate member 30 arranged on the placing table 40 at the current location PL. At this time, the object T is loaded on the plate member 30. The transport vehicle 11 and the transport vehicle 12 move to positions on the lower side of the plate member 30 and sandwiching the placing table 40 in the longitudinal direction. Next, as illustrated in FIG. 3, each transport vehicle 10 moves the cargo bed 15 upward by the lifting device 19 and lifts the plate member 30 together with the object T. As a result, each transport vehicle 10 can load the object T on the plurality of load cargo beds 15 via the plate member 30.

Step S4 is a step in which each transport vehicle 10 measures the load applied from the object T by the load measuring unit 16. As illustrated in FIG. 3, for example, when the object T is disposed on the plate member 30 so as to be shifted to one side in the longitudinal direction with respect to the center of the plate member 30 in the longitudinal direction, loads applied from the object T to the respective transport vehicles 10 may be different from each other. For example, in FIG. 3, a load M2 applied from the object T to the transport vehicle 12 is larger than a load M1 applied from the object T to the transport vehicle 11.

Step S5 is a step in which each transport vehicle 10 transmits the measurement result of the load measuring unit 16 and the current location to the transport control unit 20. The current location transmitted from the transport vehicle 10 to the transport control unit 20 in Step S5 is the position of the transport vehicle 10 when the object T is loaded in Step S4. Step S6 is a step in which the transport control unit 20 receives the measurement result of the load measuring unit 16 and the current location from each transport vehicle 10.

Step S7 is a step in which the transport control unit 20 selects a moving route of each transport vehicle 10. First, in Step S7, the transport control unit 20 extracts a transport route for transporting the object T from the current location PL to the destination DE in the workplace A. A method of extracting the transport route is not particularly limited. In this embodiment, the transport control unit 20 extracts the transport route using, for example, the A* algorithm.

In the transport control unit 20, for example, information of the passages A1 to A4 in the workplace A and position information of the current location PL and the destination DE are stored in advance. For example, the transport control unit 20 extracts two transport routes R1 and R2 illustrated in FIG. 1 as the transport routes. The transport route R1 is a route for transporting the object T from the current location PL to the destination DE through the passage A1 and the passage A2. The transport route R1 is a route for transporting the object T from the current location PL to the destination DE through the passage A1, the passage A3, and the passage A4.

Next, the transport control unit 20 extracts a moving route of each transport vehicle 10 when the object T is transported along each of the transport routes R1 and R2. A method of extracting the moving route is not particularly limited. In this embodiment, the transport control unit 20 extracts the moving route using, for example, the A* algorithm. Note that, in the present specification, the “transport route” is a selection pattern of a passage through which the object T is transported, and the “moving route” is a traveling track of the transport vehicle 10 when the object T is transported from the current location PL to the destination DE.

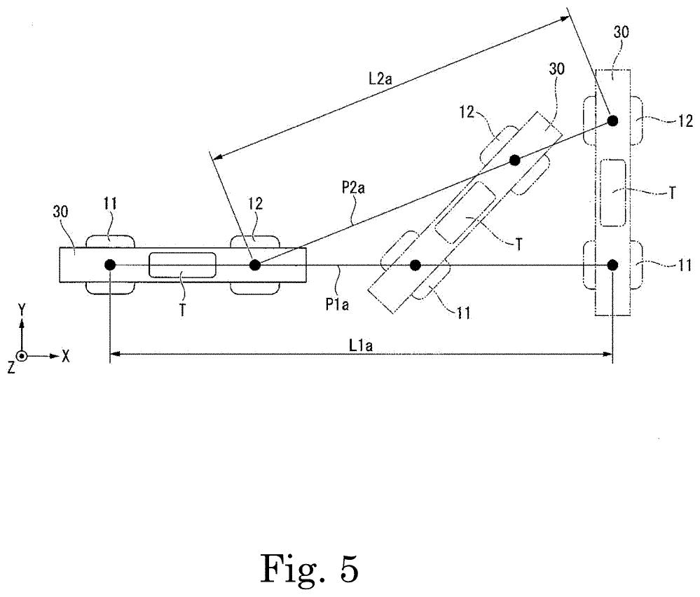

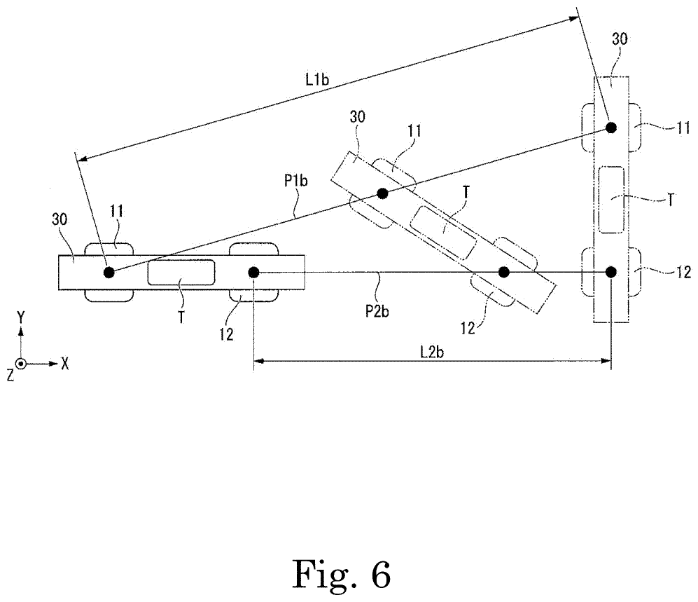

Here, even when the object T is transported along the same transport route, there may be a plurality of moving routes of each transport vehicle 10. For example, when each transport vehicle 10 turns from the passage A1 to the passage A3 on the transport route R2, a case where each transport vehicle travels in the first horizontal direction X and turns without changing the direction, and a case where each transport vehicle 10 turns while changing the direction as illustrated in FIGS. 5 and 6, can be considered. In these cases, the moving routes of the transport vehicle 10 in the transport route R2 are different from each other.

Even when each transport vehicle 10 changes its direction and turns, the moving route of each transport vehicle 10 may be different depending on the way of turning. Specifically, it is conceivable that when each transport vehicle 10 turns while changing its direction from the second horizontal direction Y to the first horizontal direction X, the transport vehicle 10 turns as illustrated in FIG. 5, and turns as illustrated in FIG. 6.

In the case illustrated in FIG. 5, the transport vehicle 11 moves along a moving route P1a, and the transport vehicle 12 moves along a moving route P2a. The moving route P1a is a route that travels straight in a direction parallel to the first horizontal direction X. The moving route P2a is a route that travels straight in a direction obliquely inclined to one side (+Y side) of the second horizontal direction Y with respect to the first horizontal direction X. Each of the transport vehicles 11 and 12 changes its direction by rotating counterclockwise as viewed from above while traveling straight along each of the moving routes P1a and P2a. In the case of the turning illustrated in FIG. 5, the plate member 30 and the object T rotate counterclockwise as viewed from above.

In the case illustrated in FIG. 6, the transport vehicle 11 moves along a moving route P1b, and the transport vehicle 12 moves along a moving route P2b. The moving route P1b is a route that travels straight in a direction obliquely inclined to one side (+Y side) of the second horizontal direction Y with respect to the first horizontal direction X. The moving route P2b is a route that travels straight in a direction parallel to the first horizontal direction X. Each of the transport vehicles 11 and 12 changes its direction by rotating clockwise as viewed from above while traveling straight along each of the moving routes P1b and P2b. In the case of the turning illustrated in FIG. 6, the plate member 30 and the object T rotate clockwise as viewed from above.

As described above, the moving route P1a of the transport vehicle 11 when turning as illustrated in FIG. 5 is different from the moving route P1b of the transport vehicle 11 when turning as illustrated in FIG. 6. The moving route P2a of the transport vehicle 12 when turning as illustrated in FIG. 5 is different from the moving route P2b of the transport vehicle 12 when turning as illustrated in FIG. 6.

As described above, in this embodiment, the transport control unit 20 holds the relative position and the relative posture between each transport vehicle 10 and the plate member 30 when moving each transport vehicle 10. Therefore, when each transport vehicle 10 changes its direction and turns, the direction of the object T and the direction of the plate member 30 also change in accordance with the direction of the transport vehicle 10. On the other hand, when each transport vehicle 10 turns without changing the direction, the direction of the object T and the direction of the plate member 30 do not change.

The transport control unit 20 extracts all the moving routes considered as the moving routes of the transport vehicles 10 for each of the transport routes R1 and R2. In this embodiment, the transport control unit 20 extracts the moving route in consideration of the direction of the object T at the destination DE. For example, when the object T is transported to the destination DE along the transport route R1, if the object T travels in the first horizontal direction X and turns without changing the direction of each transport vehicle 10 when turning from the passage A1 to the passage A2, the object T can be transported to the destination DE without changing the direction of each transport vehicle 10. However, as indicated by a two-dot chain line in FIG. 1, when it is necessary to change the direction of the object T at the destination DE to the direction of the object T at the current location PL, it is necessary to change the direction of each transport vehicle 10 at least once. Therefore, the transport control unit 20 does not extract the moving route for transporting the object T without changing the direction of the transport vehicle 10 even once.

As illustrated in FIGS. 5 and 6, the first horizontal direction X in which the object T after turning faces is reversed depending on the difference in the way of turning. Therefore, for example, even when the transport route R1 is bent as illustrated in FIG. 5, the direction of the object T in the first horizontal direction X is opposite to the direction of the object T in the first horizontal direction X indicated by the two-dot chain line in FIG. 1. Therefore, for example, the transport control unit 20 does not extract a moving route that turns as illustrated in FIG. 5 in the transport route R1.

As described above, after all the moving routes of the transport vehicles 10 capable of transporting the object T from the current location PL to the destination DE in the predetermined posture are extracted, the transport control unit 20 estimates the sum of energy consumed when the plurality of transport vehicles 10 are moved along the extracted moving routes. In this embodiment, the transport control unit 20 estimates the sum of energy consumed based on the measurement result of the load measuring unit 16 and the distance traveled by the transport vehicle 10 from the current location PL to the destination DE. The transport control unit 20 assumes that a value obtained by multiplying the measurement result of the load measuring unit 16 of the transport vehicle 10 by the distance of the moving route corresponds to the consumed energy, and estimates the sum of energy consumed by the plurality of transport vehicles 10 for each moving route.

For example, a sum E1 of energy consumed by the transport vehicles 11 and 12 when turning as illustrated in FIG. 5 is expressed by the following Expression 1, and a sum E2 of energy consumed by the transport vehicles 11 and 12 when turning as illustrated in FIG. 6 is expressed by the following Expression 2.

E1=M1×L1a+M2×L2a Expression 1

E2=M1×L1b+M2×L2b Expression 2

M1 is a load applied to the transport vehicle 11 measured by the load measuring unit 16 of the transport vehicle 11. M2 is a load applied to the transport vehicle 12 measured by the load measuring unit 16 of the transport vehicle 12. L1a is a travel distance on the moving route P1a. L2a is a travel distance on the moving route P2a. L1b is a travel distance on the moving route P1b. L2b is a travel distance on the moving route P2b.

The transport control unit 20 calculates and estimates the sum of energy consumed by the transport vehicle 10 in the entire moving routes as in the above Expressions 1 and 2. The transport control unit 20 selects moving routes of the plurality of transport vehicles 10 based on the sum of the estimated energy. In this embodiment, the transport control unit 20 selects a moving route having the smallest total sum of estimated energy from among the extracted moving routes.

Note that, for example, when there is a large deviation in the load applied from the object T to each transport vehicle 10, the sum of consumed energy tends to be the smallest by selecting the moving route in which the travel distance of the transport vehicle 10 having the larger load applied from the object T is the smallest. Therefore, in many cases, the transport control unit 20 selects the moving route in which the travel distance of the transport vehicle 10 having the larger load applied from the object T becomes the smallest.

Further, for example, as a result of extracting the moving route as described above, when there is only one moving route of each transport vehicle 10, the transport control unit 20 selects one extracted moving route without estimating the sum of energy consumed.

Step S8 is a step in which the transport control unit 20 transmits the selected moving route to each transport vehicle 10. Step S9 is a step in which each transport vehicle 10 receives the moving route from the transport control unit 20. Step S10 is a step in which each transport vehicle 10 moves to the destination along the received moving route. As a result, the plurality of transport vehicles 10 can transport the object T to the destination DE. At the destination DE, the plurality of transport vehicles 10 arrange the plate member 30 and the object T on the placing table 40 arranged at the destination DE.

For example, even when the moving route of each transport vehicle 10 in which the sum of the travel distances of the plurality of transport vehicles 10 is the smallest is selected and the object T is transported from the current location PL to the destination DE, the energy consumed in the entire transport system 1 is not necessarily the smallest when the load applied from the object T to each transport vehicle 10 is different. This is because, in a case where the loads applied to the transport vehicles 10 are greatly different, even if the travel distance of the transport vehicle 10 having the smaller applied load is increased to increase the sum of the travel distances of the plurality of transport vehicles 10, energy consumed as a whole may be reduced by reducing the travel distance of the transport vehicle 10 having the larger applied load as much as possible. Therefore, the transport efficiency of the entire transport system 1 may not be sufficiently improved. In the present specification, the “transport efficiency” includes energy efficiency, time efficiency, cost efficiency, and the like when transporting an object to a destination.

On the other hand, according to this embodiment, in a case where there is a plurality of moving routes of the plurality of transport vehicles 10 when transporting the object T from the current location PL to the predetermined destination DE, the transport control unit 20 selects each of the moving routes of the plurality of transport vehicles 10 based on the measurement result of the load measuring unit 16. Therefore, even when the loads applied from the object T to the transport vehicles 10 are different, it is easy to appropriately select the moving route in which the energy consumed by the entire transport system 1 is reduced in consideration of the difference in the applied loads. Therefore, energy consumed when the object T is transported can be reduced, and the transport efficiency of the entire transport system 1 can be improved.

Further, according to this embodiment, in a case where there is a plurality of moving routes of the plurality of transport vehicles 10 when transporting the object T from the current location PL to the destination DE, the transport control unit 20 selects the moving routes of the plurality of transport vehicles 10 based on the measurement result of the load measuring unit 16 and the distance by which the transport vehicle 10 moves from the current location PL to the destination DE. Therefore, in consideration of the difference in the load applied to each transport vehicle 10 and the difference in the distance in which each transport vehicle 10 moves, it is easy to more appropriately select the moving route in which the energy consumed in the entire transport system 1 is reduced. Therefore, energy consumed when the object T is transported can be further reduced, and the transport efficiency of the entire transport system 1 can be improved.

In addition, according to this embodiment, the transport control unit 20 estimates the sum of energy consumed until the plurality of transport vehicles 10 move from the current location PL to the destination DE based on the measurement result of the load measuring unit 16 and the distance by which the transport vehicle 10 moves from the current location PL to the destination DE. Then, the transport control unit 20 selects moving routes of the plurality of transport vehicles 10 based on the sum of the estimated energy. Therefore, it is possible to more appropriately select the moving route in which the energy consumed in the entire transport system 1 is reduced, and to further reduce the energy consumed when the object T is transported. As a result, the transport efficiency of the entire transport system 1 can be further improved.

In addition, according to this embodiment, the transport control unit 20 selects a moving route in which the sum of estimated energy is the smallest. Therefore, the energy consumed by the entire transport system 1 is easily minimized, and the energy efficiency of the entire transport system 1 is easily optimized. As a result, the transport efficiency of the entire transport system 1 can be further improved.

The present invention is not limited to the above-described embodiment, and following other structures and methods may be adopted. The transport control unit 20 is not particularly limited as long as it selects each of moving routes of the plurality of transport vehicles 10 based on the measurement result of the load measuring unit 16. The estimation of the sum of energy by the transport control unit 20 may be performed using a table stored in advance in the transport control unit 20. The table stores an estimated value of a sum of energy with respect to a load applied to the transport vehicle 10 and a travel distance of the transport vehicle 10.

The transport control unit 20 may consider energy required for rotation of the transport vehicle 10 when estimating energy consumed in the transport vehicle 10. In this case, the transport control unit 20 may regard a sum of a value obtained by multiplying the measurement result of the load measuring unit 16 of the transport vehicle 10 by the distance of the moving route and a value obtained by multiplying the inertia of the transport vehicle 10 in a state where the load is applied by the rotation angle of the transport vehicle 10 as the consumed energy. In this case, the energy consumed in each transport vehicle 10 can be estimated more accurately. The energy required for the rotation is sufficiently smaller than the energy required for the movement. Therefore, even when the energy required for rotation is not considered as in the above-described embodiment, the transport control unit 20 can estimate the energy consumed in the transport vehicle 10 sufficiently accurately.

The transport control unit 20 may select the moving route without estimating the sum of energy consumed while the plurality of transport vehicles 10 move from the current location PL to the destination DE. The transport control unit 20 may select the moving routes of the plurality of transport vehicles 10 not based on the distance by which the transport vehicle 10 moves from the current location PL to the destination DE.

The transport control unit 20 may select the moving routes of the plurality of transport vehicles 10 based on the remaining power amount of the battery 18 in the plurality of transport vehicles 10. According to this configuration, for example, when there is a deviation in the remaining power amount of the battery 18 in the plurality of transport vehicles 10, the moving distance of the transport vehicle 10 having a small remaining power amount of the battery 18 can be shortened. As a result, it is possible to suppress battery exhaustion of only some transport vehicles 10 among the plurality of transport vehicles 10, and it is possible to improve the transport efficiency of the transport system. Note that, also in this case, the transport control unit 20 may estimate the sum of consumed energy and select the moving route on the basis of the estimated sum of energy. The transport control unit 20 may select the moving route by giving priority to the sum of consumed energy, or may select the moving route by giving priority to the remaining power amount of the battery 18.

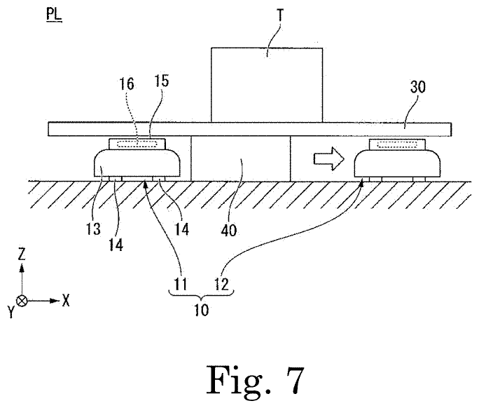

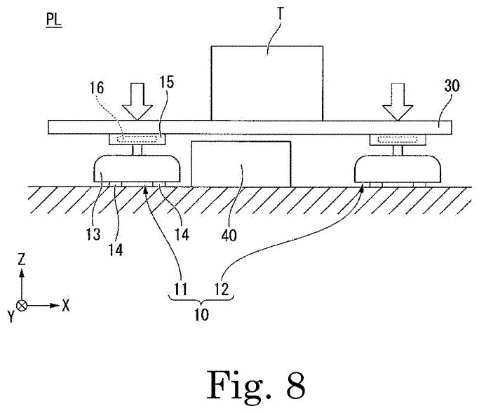

The transport control unit 20 may change the relative position in the longitudinal direction between the transport vehicle 10 and the plate member 30 based on the measurement result of the load measuring unit 16. According to this configuration, the relative distance between the object T loaded on the plate member 30 and the transport vehicle 10 can be changed, and the load applied to each transport vehicle 10 can be changed. Therefore, for example, the energy consumption of the entire transport system is easily reduced and the transport efficiency of the entire transport system is easily improved by reducing the load applied to the transport vehicle 10 whose moving distance tends to be long. As a method of changing the relative position in the longitudinal direction between the transport vehicle 10 and the plate member 30, as illustrated in FIG. 7, a method of returning the plate member 30 and the object T onto the placing table 40, then changing the position in the longitudinal direction of the transport vehicle 10, and loading the object T and the plate member 30 on the transport vehicle 10 again as illustrated in FIG. 8, can be adopted.

When changing the relative position in the longitudinal direction between the transport vehicle 10 and the plate member 30, the transport control unit 20 may change the relative position in the longitudinal direction between the transport vehicle 10 and the plate member 30 to a position where the load applied from the object T is the same in each of the plurality of transport vehicles 10. According to this configuration, it is possible to equalize the energy consumption in each transport vehicle 10 when the object travels the same moving distance. Therefore, it is easy to minimize the energy consumption of the entire transport system by simply selecting the moving route in which the sum of the travel distances of the plurality of transport vehicles 10 is the smallest. That is, when the load applied to each transport vehicle 10 measured by the load measuring unit 16 is the same, the transport control unit 20 may select, for each of the transport vehicles 10, a moving route in which the sum of the travel distances of the plurality of transport vehicles 10 becomes the smallest. As a result, the transport efficiency of the entire transport system can be improved.

Specifically, for example, when the load applied to each transport vehicle 10 is different as in the example of FIG. 3, the transport control unit 20 lowers the cargo bed 15 by the lifting device 19, and again disposes the plate member 30 and the object T on the placing table 40. In the example of FIG. 3, since the load applied to the transport vehicle 12 is larger, the transport control unit 20 moves the transport vehicle 12 in a direction away from the object T (+X direction) in the longitudinal direction as illustrated in FIG. 7. Then, as illustrated in FIG. 8, the transport control unit 20 raises the cargo bed 15 by the lifting device 19 to load the object T and the plate member 30 on the plurality of transport vehicles 10 again. In this way, the transport control unit 20 changes the relative position between the transport vehicle 10 and the plate member 30 to make the load applied to each transport vehicle 10 the same.

The control of the relative position and the relative posture of each transport vehicle 10 may be performed in such a manner that any one of the transport vehicles 10 serves as a leader machine and follows the movement of the leader machine in accordance with an instruction from the transport control unit 20, and the rest serves as a follower machine. In this case, information on the current position and posture is sequentially transmitted from the transport vehicle 10 serving as the leader machine to the transport vehicle 10 serving as the follower machine, and the transport vehicle 10 serving as the follower machine controls its own position and posture on the basis of the information. In addition, the transport vehicle 10 serving as the leader machine may select its own moving route and select the moving route of the transport vehicle 10 serving as the follower machine based on an instruction from the transport control unit 20.

The transport control unit 20 may be provided in at least one of the plurality of transport vehicles 10. In this case, the transport control unit 20 causes the transport vehicle 10 provided with the transport control unit 20 to transport the object T in cooperation with another transport vehicle 10 different from the transport vehicle 10 provided with the transport control unit 20. In this case, in a case where there is a plurality of moving routes of other transport vehicles 10 when transporting the object T from the current location PL to the destination DE, the transport vehicle 10 including the transport control unit 20 selects the moving route of the other transport vehicle 10 based on the measurement result of the load measuring unit 16 provided in the transport control unit 20 and the measurement result of the load measuring unit 16 provided in the other transport vehicle 10 by the transport control unit 20. In addition, in a case where there is a plurality of moving routes of the transport vehicle 10 including the transport control unit 20 when transporting the object T from the current location PL to the destination DE, the transport control unit 20 selects the moving route of the transport vehicle on the basis of the measurement result of the load measuring unit 16 included in the transport vehicle. As a result, energy consumption of the entire transport system can be reduced, and transport efficiency of the entire transport system can be improved, similarly to the above-described embodiment.

When the transport control unit 20 is provided in the transport vehicle 10, the transport vehicle 10 including the transport control unit 20 only needs to select a moving route of another transport vehicle 10, and does not need to select its own moving route. In this case, the moving route of the transport vehicle 10 itself including the transport control unit 20 may be selected by the transport control unit 20 provided in another transport vehicle 10 or the like. In this case, as described above, each transport vehicle 10 may be separately controlled to be the leader machine and the follower machine.

In addition, for example, when the transport control unit 20 is mounted on each of the plurality of transport vehicles 10, the transport control unit 20 of each transport vehicle 10 performs calculation on the moving routes of all the transport vehicles 10. At this time, for example, when there is a variation in the calculation result of the transport control unit 20 of each transport vehicle 10, the moving route of each transport vehicle 10 may be selected by the transport control unit 20 that has calculated a result estimated to be the most correct calculation result on the basis of each calculation result. As described above, when the calculation results vary, there is a case where it is easy to select the most suitable moving route by selecting the moving route by the transport control unit 20 provided in the other transport vehicle 10. Therefore, the energy consumption of the entire transport system can be more easily reduced, and the transport efficiency of the entire transport system can be easily improved. Note that estimating the most correct calculation result on the basis of each calculation result includes, for example, a case where, in three or more transport vehicles 10, when only the transport control unit 20 in one transport vehicle 10 calculates a calculation result different from the transport control unit 20 of the other transport vehicle 10, it is estimated that the calculation result of the transport control unit 20 of the other transport vehicle 10 is the most correct.

In the above-described embodiment, the predetermined destination DE is set as the final destination to transport the object T, but the present invention is not limited thereto. For example, the transport control unit 20 may determine one or more provisional destinations to the destination DE and select a moving route with each provisional destination as a predetermined destination. When an obstacle or the like is provided in the passage, the transport control unit 20 may grasp the position of the obstacle or the like. In this case, the transport control unit 20 selects a moving route for avoiding an obstacle or the like for each transport vehicle 10.

The transport vehicle 10 is not particularly limited as long as it can transport the object T in cooperation with the other transport vehicles 10. The plate member 30 may be fixed to the transport vehicle 10 with a fastener or the like. The transport vehicle 10 may load the object T on the cargo bed 15 without interposing the plate member 30. The transport vehicle 10 may have, for example, a hand that grips the object T. In this case, the object T may be gripped by the hands of the plurality of transport vehicles 10 and transported. In this case, the load measuring unit 16 may measure the load applied to the transport vehicle 10 by a suspension method. The wheel 14 of the transport vehicle 10 may be a wheel movable only in one of the horizontal directions. The structures of the plurality of transport vehicles 10 may be different from each other. The transport vehicle 10 may be a manned transport vehicle as long as it is controlled by the transport control unit 20. The number of transport vehicles 10 included in the transport system is not particularly limited as long as it is two or more.

In the present specification, “a plurality of transport vehicles cooperatively transport an object” means that a plurality of transport vehicles 10 may cooperatively hold and transport an object T as in the above-described embodiment, or a plurality of transport vehicles 10 may transport one or more different objects T to transport a plurality of objects T. When each of the plurality of transport vehicles 10 transports one or more mutually different objects T, for example, the plurality of transport vehicles 10 transports the object T to the same destination DE through mutually different transport routes, and whereby the time for transporting the plurality of objects T can be shortened. In this case, by selecting the moving route of each transport vehicle 10 on the basis of the measurement result of the load measuring unit 16, for example, the transport vehicle 10 that transports a heavy object T can move on a transport route having a relatively short movement distance, and the transport vehicle 10 that transports a light object T can move on a transport route having a relatively long movement distance. As a result, the energy consumption of the entire transport system can be reduced, and the transport efficiency of the entire transport system can be improved.

The environment in which the transport system of the above-described embodiment is used is not particularly limited. The object T transported by the transport system is not particularly limited. The structures described in the present specification can be combined as appropriate within a scope that does not give rise to mutual contraction.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A transport system comprising:
a plurality of transport vehicles that cooperatively transport an object; and
a transport control unit that controls the plurality of transport vehicles to transport the object,
wherein
each of the plurality of transport vehicles includes a load measuring unit that measures a load applied from the object, and
in a case where there is a plurality of moving routes of the plurality of transport vehicles when transporting the object from a current location to a predetermined destination, the transport control unit selects each of the moving routes of the plurality of transport vehicles based on a measurement result of the load measuring unit.

2. The transport system according to claim 1, wherein in a case where there is a plurality of the moving routes of the plurality of transport vehicles when transporting the object from the current location to the destination, the transport control unit selects the moving routes of the plurality of transport vehicles based on a measurement result of the load measuring unit and a distance by which the transport vehicle moves from the current location to the destination.

3. The transport system according to claim 2, wherein in a case where there is a plurality of the moving routes of the plurality of transport vehicles when transporting the object from the current location to the destination, the transport control unit estimates a sum of energy consumed until the plurality of transport vehicles move from the current location to the destination based on a measurement result of the load measuring unit and a distance by which the transport vehicle moves from the current location to the destination, and selects the moving routes of the plurality of transport vehicles based on the estimated sum of energy.

4. The transport system according to claim 3, wherein the transport control unit selects the moving route having the smallest sum of energy.

5. The transport system according to claim 1, wherein
each of the plurality of transport vehicles includes:
a motor that drives a wheel; and
a battery that supplies power to the motor, and
the transport control unit selects the moving routes of the plurality of transport vehicles based on a remaining power amount of the batteries in the plurality of transport vehicles.

6. The transport system according to claim 1, further comprising:
a plate member that extends in one direction of a horizontal direction and is supported by the plurality of transport vehicles from a vertically lower side,
wherein the plurality of transport vehicles transport the object loaded on the plate member.

7. The transport system according to claim 6, wherein the transport control unit changes a relative position between the transport vehicle and the plate member in the one direction based on a measurement result of the load measuring unit.

8. The transport system according to claim 7, wherein the transport control unit changes a relative position between the transport vehicle and the plate member in the one direction to a position where a load applied from the object is the same in each of the plurality of transport vehicles.

9. A transport vehicle comprising:
a transport control unit that transports an object in cooperation with another transport vehicle; and
a load measuring unit that measures a load applied from the object,
wherein in a case where there is a plurality of moving routes of the other transport vehicle when transporting the object from a current location to a predetermined destination, the transport control unit selects the moving route of the other transport vehicle based on a measurement result of the load measuring unit included in the transport vehicle and a measurement result of the load measuring unit included in the other transport vehicle.

10. The transport vehicle according to claim 9, wherein in a case where there is a plurality of moving routes of the transport vehicle when transporting the object from a current location to a predetermined destination, the transport control unit selects the moving route of the transport vehicle based on a measurement result of the load measuring unit included in the transport vehicle.
